(19) United States
(12) Patent Application Publication
(10) Pub. No.: US 2025/0180433 A1
(43) Pub. Date: Jun. 5, 2025

(54) BEARING TEST APPARATUS AND BEARING TEST METHOD USING THE SAME

(71) Applicant: KOREA INSTITUTE OF SCIENCE AND TECHNOLOGY, Seoul (KR)

(72) Inventors: YONG BOK LEE, Seoul (KR); Wonil KWAK, Seoul (KR); Yeong-do LEE, Seoul (KR); Jeon Kook LEE, Seoul (KR)

(21) Appl. No.: 18/912,363

(22) Filed: Oct. 10, 2024

(30) Foreign Application Priority Data
Dec. 5, 2023 (KR) 10-2023-0174841

(51) Int. Cl. G01M 13/04

(52) U.S. Cl. CPC G01M 13/04

(57) ABSTRACT

Provided is a bearing test apparatus. The bearing test apparatus includes a chamber, a rotatable part of which a portion is inserted into the chamber, a fixed part configured to support the rotatable part, a support bearing inserted between the rotatable part and the fixed part to support rotation of the rotatable part, a cooling fluid supply device configured to supply a cooling fluid into the chamber, and a heating device connected to the support bearing. The heating device is configured to heat the support bearing.

### CROSS-REFERENCE TO RELATED APPLICATIONS

This U.S. non-provisional patent application claims priority under 35 U.S.C. § 119 of Korean Patent Application No. 10-2023-0174841, filed on Dec. 5, 2023, the entire contents of which are hereby incorporated by reference.

### BACKGROUND

The present disclosure relates to a bearing test apparatus and a bearing test method using the same, and more particularly, to a bearing test apparatus that is capable of testing a bearing in a low-temperature environment and a bearing test method using the same.

A bearing may support rotation of a machine. A bearing may be used across industries. A bearing may require durability and stability. Thus, an apparatus for testing the bearing may be used. For example, the bearing test apparatus may be used to test behavior of the bearing in an actual driving environment. A bearing that is an object to be tested may rotate for a long time by using the bearing test apparatus to observe changes in characteristic of the bearing over time.

### SUMMARY

The present disclosure provides a bearing test apparatus that is capable of stably performing a test on a bearing at an extremely low temperature and a bearing test method using the same.

The present disclosure also provides a bearing test apparatus that is capable of protecting components in the apparatus and a bearing test method using the same.

The present disclosure also provides a bearing test apparatus that is capable of simplifying equipment by omitting a torquemeter and a bearing test method using the same.

The object of the present invention is not limited to the aforesaid, but other objects not described herein will be clearly understood by those skilled in the art from descriptions below.

An embodiment of the inventive concept provides a bearing test apparatus including: a chamber; a rotatable part of which a portion is inserted into the chamber; a fixed part configured to support the rotatable part; a support bearing inserted between the rotatable part and the fixed part to support rotation of the rotatable part; a cooling fluid supply device configured to supply a cooling fluid into the chamber; and a heating device connected to the support bearing, wherein the heating device is configured to heat the support bearing.

In an embodiment, the heating device may include: a heating body having a ring shape; and a connection line connected to the heating body to transmit power.

In an embodiment, the heating device may be coupled below the support bearing.

In an embodiment, the bearing test apparatus may further include a power supply device configured to supply power to the heating device.

In an embodiment, the bearing test apparatus may further include a sealing member having a ring shape, wherein the rotatable part may include: a rotation shaft member extending vertically; a rotor coupled to the rotation shaft member, wherein the fixed part may include a stator disposed below the rotor to face the rotor, and the sealing member may be disposed between the rotor and the stator, wherein the sealing member may be configured to provide a recess that is recessed upward from a bottom surface of the sealing member.

In an embodiment, the bearing test apparatus may further include a rotation motor connected to the rotatable part, wherein a torquemeter may not be provided between the rotation motor and the rotatable part.

In an embodiment of the inventive concept, a bearing test apparatus include: a chamber configured to provide a test space; a rotatable part of which at least a portion is inserted into the test space; a fixed part configured to support the rotatable part; a cooling fluid supply device configured to supply a cooling fluid into the test space; and a sealing member having a ring shape, wherein the rotatable part includes: a rotation shaft member extending in a first direction; a rotor coupled to the rotation shaft member, wherein the fixed part includes a stator disposed below the rotor to face the rotor, and the sealing member is disposed between the rotor and the stator, wherein the sealing member is configured to provide a recess that is recessed from a bottom surface of the sealing member in the first direction.

In an embodiment, the recess may have a width less than that of the sealing member, and the recess may be connected to an outer surface of the sealing member.

In an embodiment, the rotor may include: a rotor body of which at least a portion of a top surface is exposed to the test space; and a rotor cover member extending downward from an edge of the rotor body, and the stator may include: a stator body; and a stator cover member extending upward from a top surface of the stator body, wherein the stator cover member may be disposed inside the rotor cover member, wherein a level of a top surface of the stator cover member may be higher than that of a bottom surface of the rotor cover member, and the sealing member may be disposed below the bottom surface of the rotor cover member.

In an embodiment, the sealing member may include brass.

In an embodiment, the bearing test apparatus may further include: a support bearing disposed between the rotatable part and the fixed part; and a heating device connected to the support bearing to heat the support bearing.

In an embodiment of the inventive concept, a bearing test method includes: inserting a test bearing into a test bearing apparatus; rotating a rotatable part of the bearing test apparatus by using a rotation motor; and monitoring the rotation motor, wherein the bearing test apparatus includes: a chamber configured to provide a test space; the rotatable part of which at least a portion is inserted into the chamber; a fixed part configured to support the rotatable part; a cooling fluid supply device configured to supply a cooling fluid into the chamber; and the rotation motor connected to the rotatable part to provide rotational force to the rotatable part, wherein the monitoring of the rotation motor includes monitoring a current value input to the rotation motor.

In an embodiment, the inserting of the test bearing into the bearing test apparatus may include inserting the test bearing into the chamber.

In an embodiment, the inserting of the test bearing into the bearing test apparatus may further include coupling an inner ring of the test bearing to the rotatable part.

In an embodiment, when the current value detected by the monitoring of the current value input to the rotation motor is greater than or equal to a threshold value, the rotation of the rotatable part may be stopped.

In an embodiment, the bearing test method may further include, during the rotation of the rotatable part, supplying the cooling fluid into the test space by using the cooling fluid supply device.

In an embodiment, the cooling fluid may include liquid nitrogen (N₂).

In an embodiment, a torquemeter may not be provided between the rotation motor and the rotatable part.

In an embodiment, the bearing test apparatus may include: a support bearing configured to support the rotation of the rotatable part between the rotatable part and the fixed part; and a heating device connected to the support bearing, wherein the rotating of the rotatable part may include heating the support bearing by using the heating device.

In an embodiment, the beating test apparatus may further include a sealing member having a ring shape, wherein the rotatable part may include: a rotation shaft member extending vertically; a rotor coupled to the rotation shaft member, wherein the fixed part may include a stator disposed below the rotor to face the rotor, and the sealing member may be disposed between the rotor and the stator, wherein the sealing member may be configured to provide a recess that is recessed upward from a bottom surface of the sealing member.

Particularities of other embodiments are included in the detailed description and drawings.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view of a bearing test apparatus according to embodiments of the inventive concept;

FIG. 2 is an enlarged cross-sectional view of an area X of FIG. 1;

FIG. 3 is a view of a heating device according to embodiments of the inventive concept;

FIG. 4 is an enlarged cross-sectional view of an area Y of FIG. 1;

FIG. 5 is a cross-sectional view of a sealing member according to embodiments of the inventive concept;

FIG. 6 is a perspective view of the sealing member according to embodiments of the inventive concept;

FIG. 7 is a flowchart illustrating a bearing test method according to embodiments of the inventive concept; and

FIGS. 8, 9, and 10 are cross-sectional views illustrating a bearing test method according to the flowchart.

### DETAILED DESCRIPTION

Exemplary embodiments of technical ideas of the inventive concept will be described with reference to the accompanying drawings so as to sufficiently understand constitutions and effects of the inventive concept. The technical ideas of the inventive concept may, however, be embodied in different forms and should not be construed as limited to the embodiment set forth herein. Rather, these embodiments are provided so that this disclosure will be thorough and complete, and will fully convey the scope of the present invention to those skilled in the art. Further, the present invention is only defined by scopes of claims.

Like reference numerals refer to like elements throughout. The embodiments in the detailed description will be described with exemplary block diagrams, perspective views, and/or cross-sectional views as ideal exemplary views of the inventive concept. In the figures, the dimensions of regions are exaggerated for effective description of the technical contents. Regions exemplified in the drawings have general properties and are used to illustrate a specific shape of a device. Thus, this should not be construed as limited to the scope of the inventive concept. Also, although various terms are used to describe various components in various embodiments of the inventive concept, the component are not limited to these terms. These terms are only used to distinguish one component from another component. The embodiments described and exemplified herein include complementary embodiments thereof.

In the following description, the technical terms are used only for explaining a specific embodiment while not limiting the present invention. In this specification, the terms of a singular form may comprise plural forms unless specifically mentioned. The meaning of ‘comprises’ and/or ‘comprising’ does not exclude other components besides a mentioned component.

Hereinafter, the present disclosure will be described in detail by explaining preferred embodiments of the technical ideas of the inventive concept with reference to the attached drawings.

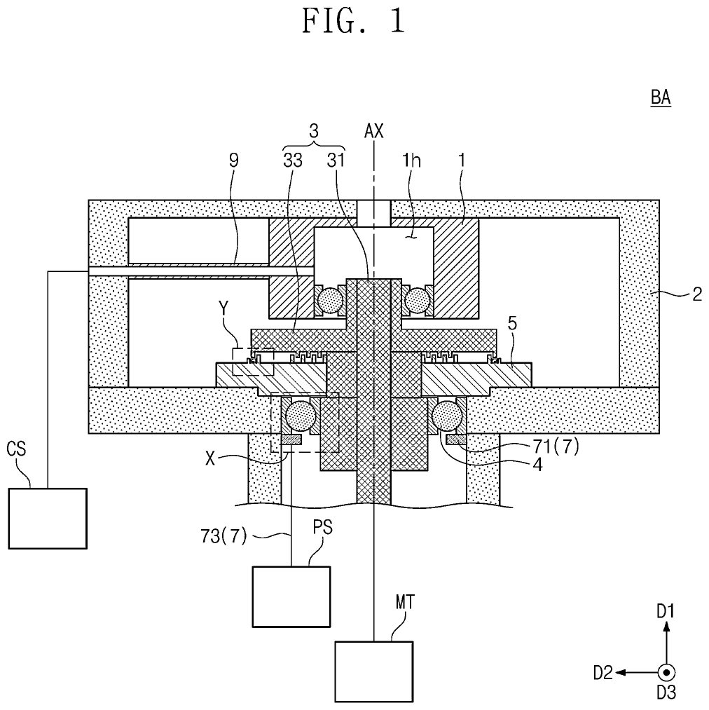

FIG. 1 is a cross-sectional view of a bearing test apparatus according to embodiments of the inventive concept.

Hereinafter, a direction D1 will be referred to as a first direction, a direction D2 intersecting the first direction D1 will be referred to as a second direction, and a direction D3 intersecting each of the first direction D1 and the second direction D2 will be referred to as a third direction. The first direction D1 may be referred to as an upward direction or vertical direction. Each of the second direction D2 and the third direction D3 may be referred to as a horizontal direction.

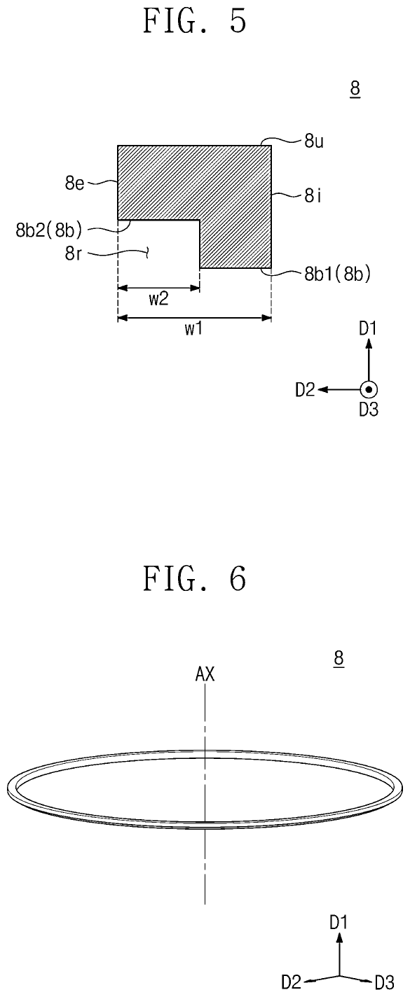

Referring to FIG. 1, a bearing test apparatus BA may be provided. The bearing test apparatus BA may be an apparatus that performs tests on a bearing. For example, the bearing test apparatus BA may perform the test on characteristics of the bearing during a long-term operation of the bearing. That is, the bearing test apparatus BA may test a lifetime of the bearing. The bearing to be tested by the bearing test apparatus BA may be a ball bearing, but is not limited thereto. The bearing that is an object to be tested may be called a test bearing. The bearing test equipment BA may test the lifetime of the bearing under various environments. More specifically, the bearing test apparatus BA may test the lifetime of the bearing in various temperature ranges. For example, the bearing test apparatus BA may test the lifetime of the bearing at an extremely low temperature. For this, the bearing test apparatus BA may include a chamber 1, a rotatable part 3, a fixed part 5, a support bearing 4, a heating device 7, a sealing member 8 (see FIG. 4), a housing 2, a cooling fluid supply device CS, a cooling fluid supply tube 9, a power supply device PS, and a rotation motor MT.

The chamber 1 may provide a test space 1h. In the state in which the test bearing is disposed in the chamber 1, the test on the test bearing may be performed. One surface of the chamber 1 may be opened. For example, as illustrated in FIG. 1, a bottom surface of the chamber 1 may be opened, and the test space 1h may be connected to an external space. However, it is not limited thereto, and the chamber 1 may be sealed.

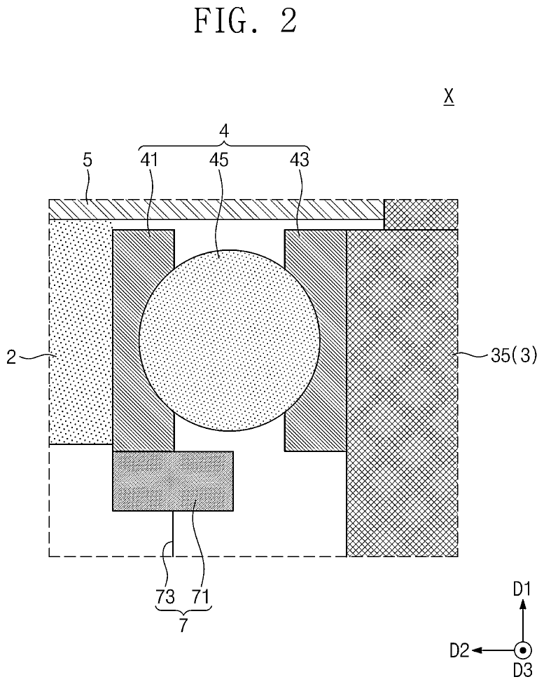

The rotatable part 3 may rotate. For example, the rotatable part 3 may rotate about an axis AX parallel to the first direction D1. At least a portion of the rotatable part 3 may be inserted into the chamber 1. The rotatable part 3 may receive rotational power from the rotation motor MT. The rotatable part 3 may include a rotation shaft member 31, a rotor 33, and a lower member 35 (see FIG. 2). The rotation shaft member 31 may extend vertically. That is, the rotation shaft member 31 may extend in the first direction D1. The rotation shaft member 31 may be connected to the rotation motor MT. For example, a lower end of the rotation shaft member 31 may be directly coupled to the rotation motor MT, but is not limited thereto. The rotor 33 may be coupled to the rotation shaft member 31. Details about the rotor 33 will be described later. The lower member 35 may be coupled to the rotation shaft member 31 and/or the rotor 33. The lower member 35 may support, for example, one side of the support bearing 4. That is, a portion of the support bearing 4 may be fixedly coupled to the lower member 35. However, the embodiment of the inventive concept is not limited thereto. Details about the lower member 35 will be described later.

The fixed part 5 may support the rotatable part 3. While the rotatable part 3 rotates, the fixed part 5 may not rotate. The fixed part 5 may include a stator 51 (see FIG. 4). Details on this process will be described later.

The support bearing 4 may support the rotation of the rotatable part 3. The support bearing 4 may be inserted between the rotatable part 3 and the fixed part 5. A portion of the support bearing 4 may be coupled to the rotatable part 3. The other portion of the support bearing 4 may be coupled to the fixed part 5. The support bearing 4 may include, for example, a ball bearing, but is not limited thereto. More details about the support bearing 4 will be described later.

The heating device 7 may heat the support bearing 4. The heating device 7 may be connected to the support bearing 4. For example, the heating device 7 may be coupled below the support bearing 4, but is not limited thereto. The heating device 7 may include a heating body 71 and a connection line 73. Details on this process will be described later.

The sealing member 8 (see FIG. 4) may be disposed between the fixed part 5 and the rotatable part 3. More specifically, the sealing member 8 may be inserted between the rotor 31 and the stator 51 (see FIG. 4). More specific details about the sealing member 8 will be described later.

The housing 2 may surround the chamber 1, etc. The housing 2 may fix the fixed part 5. That is, the fixed part 5 may be fixedly coupled to the housing 2 so as not to move.

The cooling fluid supply device CS may supply a cooling fluid into the chamber 1. That is, the cooling fluid supply device CS may supply the cooling fluid to the test space 1h to reduce a temperature of the test bearing disposed in the test space 1h. For this, the cooling fluid supply device CS may include a cooling fluid tank, a compressor, and/or a valve. The cooling fluid supplied by the cooling fluid supply device CS may include, for example, liquid nitrogen (N₂), but is not limited thereto.

The cooling fluid supply pipe 9 may connect the cooling fluid supply device CS to the chamber 1. One end of the cooling fluid supply pipe 9 may be connected to the cooling fluid supply device CS. The other end of the cooling fluid supply pipe 9 may be connected to the test space 1h. The cooling fluid supplied from the cooling fluid supply device CS may flow along the cooling fluid supply pipe 9 to flow into the test space 1h.

The power supply PS may supply power to the heating device 7. For this, the power supply PS may be connected to the heating device 7. For example, the power supply device PS may be connected to the heating body 71 through the connection line 73.

The rotation motor MT may provide rotational power to the rotation part 3. For this purpose, the rotation motor MT may be connected to the rotation part 3. For example, the rotation motor MT may be coupled to a lower end of the rotation shaft member 31. A torquemeter may not be provided between the rotation motor MT and the rotation part 3. That is, the bearing test apparatus BA may not include the torquemeter. Details on this process will be described later.

Although not shown, the bearing test apparatus BA may further include a pressure sensor, a temperature sensor, and/or an acoustic sensor. The pressure sensor and/or the temperature sensor may be disposed, for example, between the rotor 33 and the stator 51. The acoustic sensor may be disposed on the outside of the housing 2, but is not limited thereto.

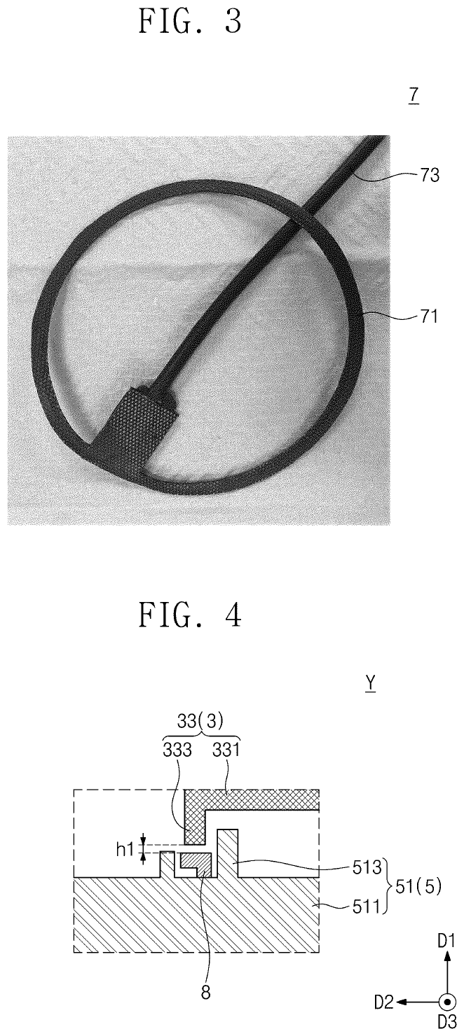

FIG. 2 is an enlarged cross-sectional view of an area X of FIG. 1, and FIG. 3 is a view of a heating device according to embodiments of the inventive concept.

Referring to FIG. 2, the support bearing 4 may include an outer ring 41, an inner ring 43, and a support ball 45. The outer ring 41 may be coupled to the fixed part 5 and/or the housing 2. For example, as illustrated in FIG. 2, the outer ring 41 may be fixedly coupled to the housing 2. The inner ring 43 may be coupled to the rotatable part 3. For example, as illustrated in FIG. 2, the inner ring 43 may be fixedly coupled to the lower member 35.

Referring to FIGS. 2 and 3, the heating body 71 may have a ring shape. The heating body 71 may include a heating wire or the like. Therefore, when power is supplied to the heating body 71, heat may be generated from the heating body 71. The heating body 71 may be connected to the support bearing 4. For example, the heating body 71 may be coupled below the support bearing 4. More specifically, as illustrated in FIG. 2, the heating body 71 may be coupled to a bottom surface of the outer ring 41. However, it is not limited thereto, and the heating body 71 may be connected to the support bearing 4 in another form. The connection line 73 may include a wire made of a flexible material, but is not limited thereto.

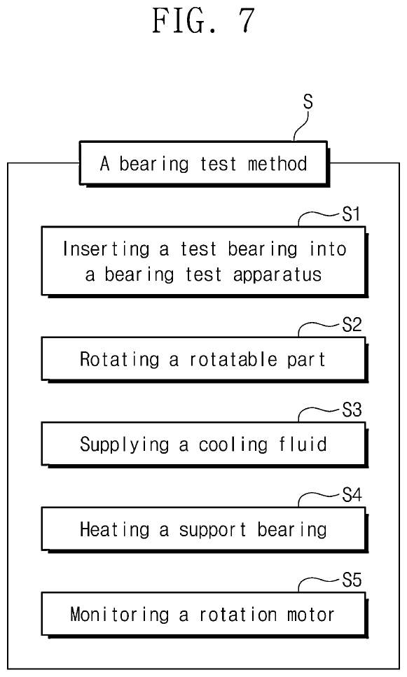

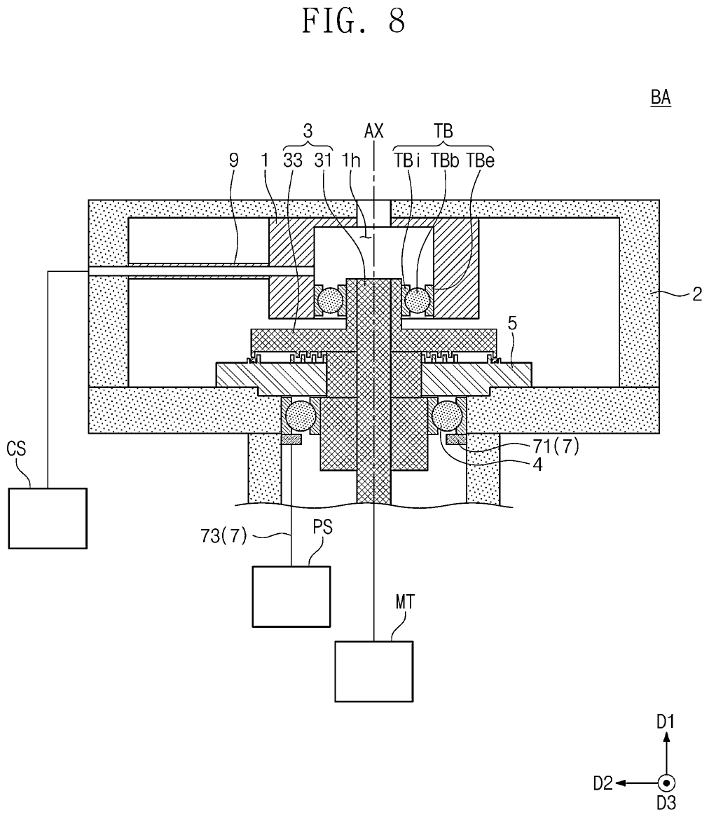

FIG. 4 is an enlarged cross-sectional view of an area Y of FIG. 1, FIG. 5 is a cross-sectional view of a sealing member according to embodiments of the inventive concept, and FIG. 6 is a perspective view of the sealing member according to embodiments of the inventive concept.

Referring to FIG. 4, the rotor 33 may include a rotor body 331 and a rotor cover member 333. The rotor body 331 may have, for example, a disk shape. At least a portion of a top surface of the rotor body 331 may be exposed to the test space 1h (see FIG. 1), but is not limited thereto. The rotor cover member 333 may be coupled to a bottom surface of the rotor body 331. For example, the rotor cover member 333 may extend downward from an edge of the rotor body 331. The rotor cover member 333 may have, for example, a ring shape, but is not limited thereto.

The stator 51 may be disposed below the rotor 33. The stator 51 may face the rotor 33. The stator 51 may include a stator body 511 and a stator cover member 513. The stator body 511 may have a disk shape, for example, but is not limited thereto. The stator cover member 513 may extend upward from a top surface of the stator body 511. The stator cover member 513 may have a ring shape, for example, but is not limited thereto.

The stator cover member 513 may be disposed inside the rotor cover member 333. That is, the shortest distance between the axes AX (see FIG. 1) of the stator cover member 513 may be less than the shortest distance between the rotor cover member 333 and the axis AX. A level of the top surface of the stator cover member 513 may be higher than that of a bottom surface of the rotor cover member 333. The sealing member 8 may be disposed under the bottom surface of the rotor cover member 333. When the rotatable part 3 does not rotate, the sealing member 8 may be in contact with the top surface of the stator body 511. The top surface of the sealing member 8 may be spaced downward from the bottom surface of the rotor cover member 333. A distance between the top surface of the sealing member 8 and the bottom surface of the rotor cover member 333 may be referred to as a spaced distance h1.

Referring to FIGS. 4 and 6, the sealing member 8 may have a ring shape. The sealing member 8 may include brass, but is not limited thereto.

Referring to FIG. 5, the sealing member 8 may provide a recess 8r. The recess 8r may be defined by being recessed from a bottom surface 8b of the sealing member 8 in the first direction D1. That is, a portion 8b2 of the bottom surface 8b of the sealing member 8 may be recessed upward to define the recess 8r. The other portion 8b1 of the bottom surface 8b of the sealing member 8 may be in contact with the top surface of the stator body 511 (see FIG. 4) when the rotatable part 3 (see FIG. 3) does not rotate. The recess 8r may be connected to an outer surface 8e of the sealing member 8. A width w2 of the recess 8r may be less than a width w1 of the sealing member 8. Thus, the recess 8r may not be connected to an inner surface 8i of the sealing member 8.

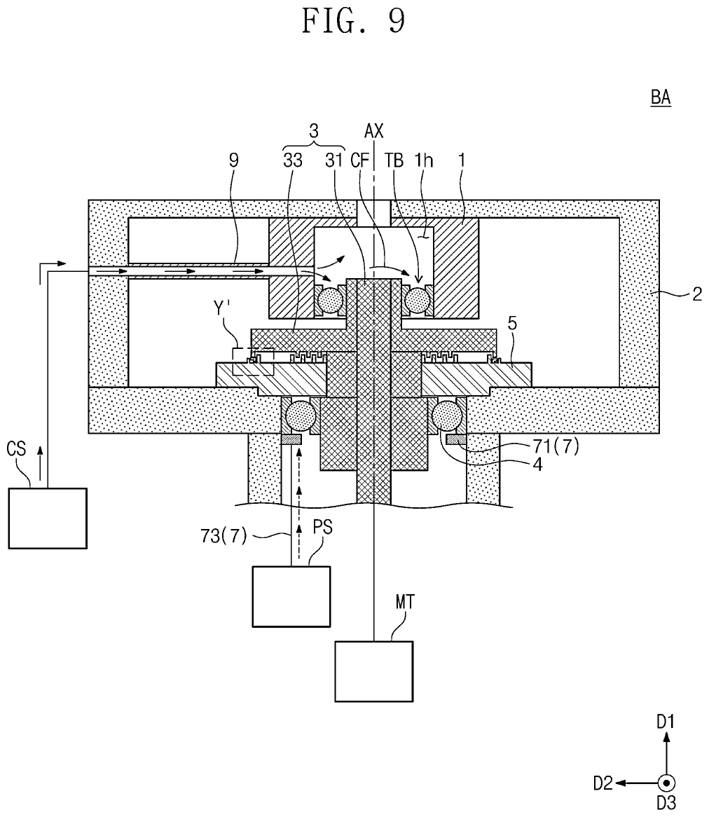

FIG. 7 is a flowchart illustrating a bearing test method according to embodiments of the inventive concept.

Referring to FIG. 7, a bearing test method S may be provided. The bearing test method S may be a method for performing a test on a bearing using the bearing test apparatus BA (see FIG. 1) described with reference to FIGS. 1 to 6. In the bearing test method S, the bearing that is an object to be tested may be called a test bearing. The test bearing may include a ball bearing as described above, but is not limited thereto. The bearing test method S may include a process (S1) of inserting the test bearing into the bearing test apparatus, a process (S2) of rotating a rotatable part, a process (S3) of supplying a cooling fluid, a process (S4) of heating a support bearing, and a process (S5) of monitoring a rotation motor.

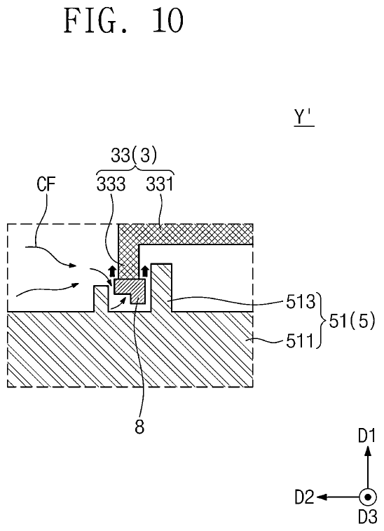

Hereinafter, the bearing test method S of FIG. 7 will be described in detail with reference to FIGS. 8 to 10.

FIGS. 8 to 10 are cross-sectional views illustrating the bearing test method according to the flowchart.

Referring to FIGS. 8 and 7, the process (S1) of inserting the test bearing into the bearing test apparatus may include a process of inserting a test bearing TB into a chamber 1. The test bearing TB may include an inner ring TBi, an outer ring TBe, and a test ball TBb. The inner ring TBi may be connected to the rotatable part 3. That is, the process (S1) of inserting the test bearing into the bearing test apparatus may further include a process of coupling the inner ring TBi to the rotatable part 3. For example, the inner ring TBi may be fixedly coupled to a rotation shaft member 31 and/or a rotor 33. Therefore, the inner ring TBi may rotate together with the rotatable part 3. The outer ring TBe may not rotate. For this, the outer ring TBe may be fixedly coupled to the chamber 1, the fixed part 5, and/or the housing 2.

Referring to FIGS. 9 and 7, the process (S2) of rotating the rotatable part may include a process of rotating the rotatable part 3 about the axis AX by the power provided by the rotation motor MT. As the rotatable part 3 rotates, the test bearing TB coupled to the rotatable part 3 may also rotate.

The process (S3) of supplying the cooling fluid may include a process of supplying the cooling fluid CF to a test space 1h using a cooling fluid supply device CS. The cooling fluid CF may include, for example, liquid nitrogen (N₂), but is not limited thereto. The test bearing TB in the test space 1h may be maintained in a cryogenic state by the cooling fluid CF.

The process (S4) of heating the support bearing may include a process of heating the support bearing 4 using a heating device 7. More specifically, the power supplied from the power supply device PS may be transmitted to the heating body 71 through a connection line 73, and thus, the heating body 71 may emit heat. Thus, a temperature of the support bearing 4 may rise. Thus, the support bearing 4 may be prevented from being damaged by being brought to the cryogenic state by the cooling fluid. More specifically, the support bearing 4 may be brought to the cryogenic state by the cooling fluid to prevent oil freezing from occurring.

The process (S5) of monitoring the rotation motor may include a process of monitoring a current value input to the rotation motor MT. When an abnormality occurs in the current value input to the rotation motor MT, it may mean that an abnormality has occurred in the test bearing TB and/or the bearing test apparatus BA. Therefore, when the current value input to the rotation motor MT is greater than or equal to a threshold value, the rotation of the rotation part 3 may be stopped. Thus, the bearing test apparatus BA may be prevented from being damaged.

Referring to FIG. 10, a portion of the cooling fluid CF may move onto the stator 51. A portion of the cooling fluid CF may move to the vicinity of the sealing member 8. When the cooling fluid CF flows into a recess 8r (see FIG. 5) of the sealing member 8, the sealing member 8 may be forced upward. Thus, the sealing member 8 may ascend. A distance between the sealing member 8 and the rotor 33 may be reduced. Thus, the cooling fluid CF may be prevented from moving inward beyond the sealing member 8.

Although not shown, the sealing element 8 may measure a sealing effect using a pressure sensor and/or a temperature sensor. If the sealing effect by the sealing member 8 is not sufficient, and the cooling fluid moves inward beyond the sealing member 8, an abnormal signal may be detected in the pressure sensor and/or the temperature sensor.

Although not shown, noise generated from the bearing test apparatus may be measured using an acoustic sensor. Thus, failures may be predicted in advance.

According to the bearing test apparatus and the bearing test method using the same according to embodiments of the inventive concept, the test on the test bearing may be performed in the cryogenic state, and also, the support bearing and the rotation shaft member may be prevented from being damaged due to freeze. More specifically, the support bearing may be heated by using the heating device to prevent the support bearing from reaching an extremely low temperature. Thus, the support bearing may be prevented from being damaged. In addition, the sealing member may be used to prevent the cooling fluid from flowing into the rotation shaft member, etc. Thus, the rotation shaft member, etc. may be prevented from being damaged.

According to the bearing test apparatus and the bearing test method using the same according to embodiments of the inventive concept, the state of the bearing test apparatus may be diagnosed using the current value input to the rotation motor, and further, its failure may be predicted. As a result, a separate torquemeter may not be required to diagnose the condition of the bearing test apparatus. Therefore, the overall equipment may be simplified and cheaper.

According to the bearing test apparatus and the bearing test method using the same of the inventive concept, the test on the bearing at the extremely low temperature may be stably performed.

According to the bearing test apparatus and the bearing test method using the same of the inventive concept, the component within the apparatus may be protected from the external low temperature.

According to the bearing test apparatus and the bearing test method using the same of the inventive concept, the torquemeter may be omitted to simplify the equipment.

The effects of the inventive concept invention are not limited to the aforementioned object, but other effects not described herein will be clearly understood by those skilled in the art from descriptions below.

Although the embodiment of the present invention is described with reference to the accompanying drawings, those with ordinary skill in the technical field of the present invention pertains will be understood that the present invention can be carried out in other specific forms without changing the technical idea or essential features. Thus, the above-disclosed embodiments are to be considered illustrative and not restrictive.

### STATEMENT REGARDING PRIOR DISCLOSURES BY THE INVENTOR OR A JOINT INVENTOR

The inventors of the present application have made related disclosure in Yeongdo Lee et al., “Tribological Performance Test of Ball Bearing under the Cryogenic Environment,” STLE Annual Meeting, May 21, 2023. The related disclosure was made less than one year before the effective filing date (Dec. 5, 2023) of the present application, and the present application names an additional person as joint inventors relative to the persons named as authors in the related disclosure. Accordingly, it is apparent that the related disclosure is a grace period inventor disclosure and, thus the related disclosure is disqualified as prior art under 35 USC 102(a)(1) against the present application. See 35 USC 102(b)(1)(A).

What is claimed is:

1. A bearing test apparatus comprising:
a chamber;
a rotatable part of which a portion is inserted into the chamber;
a fixed part configured to support the rotatable part;
a support bearing inserted between the rotatable part and the fixed part to support rotation of the rotatable part;
a cooling fluid supply device configured to supply a cooling fluid into the chamber; and
a heating device connected to the support bearing,
wherein the heating device is configured to heat the support bearing.

2. The bearing test apparatus of claim 1, wherein the heating device comprises:
a heating body having a ring shape; and
a connection line connected to the heating body to transmit power.

3. The bearing test apparatus of claim 1, wherein the heating device is coupled below the support bearing.

4. The bearing test apparatus of claim 1, further comprising a power supply device configured to supply power to the heating device.

5. The bearing test apparatus of claim 1, further comprising a sealing member having a ring shape,
wherein the rotatable part comprises:
a rotation shaft member extending vertically;
a rotor coupled to the rotation shaft member,
wherein the fixed part comprises a stator disposed below the rotor to face the rotor, and
the sealing member is disposed between the rotor and the stator, wherein the sealing member is configured to provide a recess that is recessed upward from a bottom surface of the sealing member.

6. The bearing test apparatus of claim 1, further comprising a rotation motor connected to the rotatable part,
wherein a torquemeter is not provided between the rotation motor and the rotatable part.

7. A bearing test apparatus comprising:
a chamber configured to provide a test space;
a rotatable part of which at least a portion is inserted into the test space;
a fixed part configured to support the rotatable part;
a cooling fluid supply device configured to supply a cooling fluid into the test space; and
a sealing member having a ring shape,
wherein the rotatable part comprises:
a rotation shaft member extending in a first direction;
a rotor coupled to the rotation shaft member,
wherein the fixed part comprises a stator disposed below the rotor to face the rotor, and
the sealing member is disposed between the rotor and the stator, wherein the sealing member is configured to provide a recess that is recessed from a bottom surface of the sealing member in the first direction.

8. The bearing test apparatus of claim 7, wherein the recess has a width less than that of the sealing member, and
the recess is connected to an outer surface of the sealing member.

9. The bearing test apparatus of claim 7, wherein the rotor comprises:
a rotor body of which at least a portion of a top surface is exposed to the test space; and
a rotor cover member extending downward from an edge of the rotor body, and
the stator comprises:
a stator body; and
a stator cover member extending upward from a top surface of the stator body,
wherein the stator cover member is disposed inside the rotor cover member,
wherein a level of a top surface of the stator cover member is higher than that of a bottom surface of the rotor cover member, and
the sealing member is disposed below the bottom surface of the rotor cover member.

10. The bearing test apparatus of claim 7, wherein the sealing member comprises brass.

11. The bearing test apparatus of claim 7, further comprising:
a support bearing disposed between the rotatable part and the fixed part; and
a heating device connected to the support bearing to heat the support bearing.

12. A bearing test method comprising:
inserting a test bearing into a test bearing apparatus;
rotating a rotatable part of the bearing test apparatus by using a rotation motor; and
monitoring the rotation motor,
wherein the bearing test apparatus comprises:
a chamber configured to provide a test space;
the rotatable part of which at least a portion is inserted into the chamber;
a fixed part configured to support the rotatable part;
a cooling fluid supply device configured to supply a cooling fluid into the chamber; and
the rotation motor connected to the rotatable part to provide rotational force to the rotatable part,
wherein the monitoring of the rotation motor comprises monitoring a current value input to the rotation motor.

13. The bearing test method of claim 12, wherein the inserting of the test bearing into the bearing test apparatus comprises inserting the test bearing into the chamber.

14. The bearing test method of claim 13, wherein the inserting of the test bearing into the bearing test apparatus further comprises coupling an inner ring of the test bearing to the rotatable part.

15. The bearing test method of claim 12, wherein, when the current value detected by the monitoring of the current value input to the rotation motor is greater than or equal to a threshold value, the rotation of the rotatable part is stopped.

16. The bearing test method of claim 12, further comprising, during the rotation of the rotatable part, supplying the cooling fluid into the test space by using the cooling fluid supply device.

17. The bearing test method of claim 16, wherein the cooling fluid comprises liquid nitrogen (N₂).

18. The bearing test method of claim 12, wherein a torquemeter is not provided between the rotation motor and the rotatable part.

19. The bearing test method of claim 12, wherein the bearing test apparatus comprises:
a support bearing configured to support the rotation of the rotatable part between the rotatable part and the fixed part; and
a heating device connected to the support bearing,
wherein the rotating of the rotatable part comprises heating the support bearing by using the heating device.

20. The bearing test method of claim 12, wherein the beating test apparatus further comprises a sealing member having a ring shape,
wherein the rotatable part comprises:
a rotation shaft member extending vertically;
a rotor coupled to the rotation shaft member,
wherein the fixed part comprises a stator disposed below the rotor to face the rotor, and
the sealing member is disposed between the rotor and the stator, wherein the sealing member is configured to provide a recess that is recessed upward from a bottom surface of the sealing member.
